(19) United States
(12) Patent Application Publication
(10) Pub. No.: US 2011/0315914 A1
(43) Pub. Date: Dec. 29, 2011

(54) NANOCOMPOSITES WITH HIGH DIELECTRIC CONSTANT

(75) Inventors: ZHIYUN CHEN, ROCKVILLE, MD (US); JUN XU, Greenbelt, MD (US); BRIAN L. WEHRENBERG, College Park, MD (US); ZEHRA SERPIL GONEN-WILLIAMS, LANHAM, MD (US); GREGORY D. COOPER, Arlington, VA (US)

(73) Assignee: PIXELLIGENT TECHNOLOGIES, LLC, Baltimore, MD (US)

(21) Appl. No.: 13/172,216

(22) Filed: Jun. 29, 2011

Related U.S. Application Data
(60) Provisional application No. 61/359,406, filed on Jun. 29, 2010.

(51) Int. Cl. H01F 1/06; C09K 5/00; C08L 63/00; C08L 33/08; C08L 75/04; C03C 14/00; C08L 67/02; C08L 77/00; C08L 69/00; C08L 79/08; C09D 7/12; C09K 3/00; C08L 75/02

(52) U.S. Cl. 252/62.55; 252/182.11; 252/71; 252/387; 252/182.33; 252/182.32; 252/182.34; 252/182.3; 252/182.12; 523/400; 524/560; 524/590; 524/589; 524/605; 524/606; 524/611; 106/287.13; 106/287.24; 106/287.26; 106/287.3; 106/287.32; 106/287.23; 106/287.29; 501/32; 977/773

(57) ABSTRACT

A nanocomposite with high dielectric constant includes both ferroelectric with non-ferroelectric fillers. This may improve, not only the dielectric constant of the nanocomposite but also provide additional thermal, electrical, optical, mechanical, or chemical properties to the nanocomposite for specific applications.

### CROSS-REFERENCES TO RELATED APPLICATIONS

This application claims the benefit of U.S. Provisional Application No. 61/359,406 filed Jun. 29, 2010, the entire contents of which is hereby incorporated by reference.

### STATEMENT REGARDING FEDERALLY SPONSORED RESEARCH OR DEVELOPMENT

An effort to produce a specific embodiment of the technology herein is currently being funded by a US Air Force SBIR Phase I grant No. FA8650-10-M-5106, titled “Adaptive Thermal Control Coatings for Radiation Hardening of Spacecrafts”.

### FIELD

The technology herein relates to nanocomposites, and more particularly to applications of one or more type of inorganic nanocrystals incorporated into a polymeric binder to form a nanocomposite. At least one example type of said nanocrystals is a ferroelectric material possessing high dielectric constant. The technology herein also relates to said nanocrystals providing additional electrical, thermal, optical, and chemical properties specific for various applications including electrostatically dissipative (ESD) coatings and high density electrical storage, or other applications.

### BACKGROUND AND SUMMARY

### Nanocomposites

Nanocomposites are a rapidly developing family of materials. They have a wide array of applications. A nanocomposite is a synthetic material composed of one or more types of nanocrystals (i.e. fillers), usually embedded in a binder. A nanocomposite often demonstrates a set of properties that none of its constituent materials possesses. Nanocrystals typically refer to materials having sub-micron size in at least one dimension. Nanocrystals assume a variety of shapes including nano-spheres, nano-cubes, nano-rods, nano-flakes, nano-disks, nano-rices, nano-donuts, nano-wires, nano-branches, nano-whiskers, tetrapods, and other nanoscale shapes.

The surfaces of nanocrystals are often capped with ligands to promote better dispersion into a binder or provide additional functionalities. For example, silane agents (see US provisional patent application No: 61327313, entitled “Synthesis, Capping and Dispersion of Nanocrystals” incorporated herein by reference) can improve the dispersion of nanocrystal in a polymer binder, such as epoxy or poly(methyl methacrylate) (PMMA). Specifically, epoxy terminated silane agents can cross link with the epoxy matrix and significantly improve the interface between the nanocrystal and the polymer binder.

Nanocrystals often demonstrate novel properties which are not present in their bulk counterparts. For example, size quantization in cadmium selenide (CdSe) nanocrystals causes the optical absorption to be shifted from the red end of the visible spectrum to the blue end by only changing the size of the nanocrystals.

Advantages of nanocomposites include that the nano-scale size of the filler materials allows integration of the novel properties of the constituent nanomaterials, better dispersion and interaction among the constituent materials, and creation of emergent properties that none of the constituents possesses. For example, superferromagnetism is a phenomenon that exists in nanocomposites containing ferromagnetic nanocrystals.

### Ferroelectric Materials

Ferroelectric material is the electrical analogy of the ferromagnetic material. A ferroelectric material exhibits spontaneous electric polarization that can be reversed by the application of an external electric field. Examples of ferroelectric material include barium titanate (BTO), barium strontium titanate (BST), lead titanate (LTO), lead zirconate titanate (PZT), lead lanthanum zirconate titanate (PLZT), lead magnesium niobate (PMN), potassium niobate, potassium sodium niobate, etc. A ferroelectric material undergoes a phase transition from ferroelectric phase to paraelectric phase when the temperature increases across the Curie temperature.

Ferroelectric materials also demonstrate size effect at the nanometer regime. It was shown in BTO nanoparticles that, as the size become smaller, usually starting around 300-500 nm, the Curie temperature decreases and eventually the material becomes a paraelectric material at all temperatures. (Q. Jiang, X. F. Cui, M. Zhao, “Size Effects On Curie Temperature of Ferroelectric Particles”, Appl. Phys. A, 78, 703-704 (2004).) For simplicity in this disclosure, we still refer to these nanocrystals as “ferroelectric” even if they have lost the ferroelectric phase entirely as a result of size effect. The temperature dependence of the dielectric constant, i.e. relative permittivity, also reduces as the particle size decreases.

Ferroelectric materials usually posses exceptionally high dielectric constants. For example, the maximum dielectric constant of bulk BTO can be as high as 10,000. This makes them particular popular in applications where high dielectric constant is a priority, such as capacitors and non-volatile memories.

### High Dielectric Nanocomposites

High dielectric nanocomposites with dielectric constant larger than 10 are used in applications where thin film crystalline materials are difficult to apply, such as high-k materials for embedded capacitors in IC packaging and electrostatically dissipative (ESD) coatings for static protection. For example, embedding discreet components such as capacitors and resistors into the integrated circuit (IC) package enables the semiconductor industry to continue to shrink the size of an electronic system, especially for high frequency applications such as cell phones and other communication devices. The embedded capacitors are subject to the scaling pressure dictated by Moore's law. The ever smaller size requirement of these capacitors demands ever higher dielectric constant materials. Due to its potential to be compatible with the packaging process of the IC manufacturing, nanocomposites are considered to be a very promising option for embedded applications.

Approaches to achieving high dielectric constant in nanocomposites include the effective medium approach and the percolation approach.

In the effective medium approach, a non-conducting filler with high dielectric constant, such as BTO, is incorporated into a insulating binder with smaller dielectric constant. The binder usually provides applicability, adhesion, and/or flexibility for the nanocomposite. The dielectric constant of such a composite may be described based on Maxell Model, Lichteneker Model, or Jayasundere and Smith Model, depending on the shape, size, and the nature of the dispersion. In all these models, even if the filler has a dielectric constant larger than 1000, the volume loading has to be very high, typically 50 vol % or higher, for the dielectric constant of the nanocomposite to reach 50-100 level. The high loading, however, affects the mechanical properties of the nanocomposite, making it very viscous, brittle, and less adhesive.

A problem specifically associated with using ferroelectric materials as filler in the effective medium approach is that the dielectric constant of ferroelectric materials strongly depends on temperature. This is particularly disfavored for capacitor applications and certain ESD applications where temperature stability is required. To reduce the temperature dependence, smaller nanocrystal size may be used. As shown in the literature, small size significantly reduces the temperature dependence of BTO nanocrystals (Q. Jiang, X. F. Cui, M. Zhao, “Size Effects On Curie Temperature of Ferroelectric Particles”, Appl. Phys. A, 78, 703-704 (2004), incorporated herein by reference).

The percolation approach is to use metallic or semiconducting nanocrystals as filler in a binder. According to percolation theory, when the loading level of this type of nanocomposites approaches the percolation threshold, the dielectric constant can reach a very high value. By using high aspect ratio fillers, such as nano-rods, nano-wires, nano-whiskers, or tetrapods, the percolation threshold can be easily reduced. Nanocomposites using silver nano-wires as the filler has reached a dielectric constant as high as 800 at only 20 vol % loading (Wang et. al., “Fabrication of Novel Ag Nanowires/Poly(Vinylidene Fluoride) Nanocomposite Film With High Dielectric Constant”, Physica Status Solidi (a), Mar. 1, 2010, online early publication, incorporated herein by reference). The reduced loading requirement can significantly improve the mechanical properties of the nanocomposite and make room for additional fillers for additional functionalities.

Even a material that has low dielectric constant in the bulk form, such as ZrO₂, may show a large dielectric constant when made into nanocrystalline form and included into a nanocomposite. The more conductive interior of the nanocrystals and the insulating surfaces and boundaries among the nanocrystals form a two-phase system. Depending on the particular geometry of the system, the system may be near the percolation threshold and therefore demonstrate large dielectric constant.

The percolation approach, however, also has its limitations. First, the high dielectric constant can generally only be achieved near the narrow loading range before the percolation threshold occurs. A small variation of the loading significantly alters the overall dielectric constant of the nanocomposite. Second, the nanocomposite is highly conductive, making it unacceptable for capacitors and non-conducting anti-static coating applications. And lastly, for some special applications such as a thermal control coating, highly conductive material usually reduces the emittance/absorptance ratio, a major performance indicator for such a material.

To overcome the aforementioned challenges, it may be advantageous to combine the two approaches by dispersing high dielectric constant nanocrystals and high aspect ratio conducting, i.e. metallic or semiconducting, nanocrystals into the binder to meet the different requirements of different applications. As mentioned earlier, for a material having relatively low bulk dielectric constant, such as ZrO₂, when made into nanocrystalline form it may demonstrate high dielectric constant itself. Incorporating nanocrystals of such a material into a nanocomposite comprising at least one ferroelectric filler may further improve the dielectric constant of the nanocomposite.

It is also possible to further improve the dielectric constant by using high dielectric constant binders.

### Electrostatically Dissipative Coatings

ESD coatings have a broad range of applications. In many environments, charge accumulation may occur at the surface of an object as a result of electron or ion flux from space, triboelectric charge, or lightening. The building up of charges may create high surface voltage and eventually lead to electrical break down, which may cause permanent damage and/or electronic interference. ESD coatings serve as protecting layers to prevent such a buildup of electrical charges.

Traditional ESD coatings are either metallic or containing metallic fillers to create a highly conductive surface to prevent charge accumulation. However, in some applications, the metallic or high conductivity of these coatings may interfere with other requirements of the coatings.

One example of such application is the thermal control coating for radiation hardening of spaceships. Due to the harsh environment of the space, the outermost layer of a spacecraft needs to protect against multiple hazards, such as heat from the sun, high radiation flux of both low energy electrons from solar winds or man-made nuclear events, and corrosion caused by atomic oxygen, just to name a few. In the case of low energy electron radiation, the spacecraft will be electrically charged by the electrons impinged on the surface, resulting in a surface voltage that will build up if these charges are not dissipated to a common ground. Electrostatic discharge may occur if the surface voltage becomes high enough. The arcs created by these discharges can interfere with the communication and telemetry systems on board. In severe cases, dielectric breakdown damages the coating and the spacecraft. The outmost coating therefore has to serve as an ESD coating, which is crucial to protect the spacecraft against the low energy electron radiation. The coating also has to serve as the thermal control coating of the spacecraft. As a thermal control coating it has to provide high emittance/absorptance ratio and sufficient thermal conductivity to prevent the spacecraft from over heating by the sun. Metallic or highly conductive coatings usually have low emissivity/absorption ratio in the near ultraviolet (UV) to infrared (IR) spectral range. Complex multi-layered ESD coatings are sometimes designed to mitigate this problem.

Another example of such application is the ESD coatings for land based telescope or oil or gas storage tanks. The sources of electrical charges here are either the electron or ion flux existing at high altitude, lightening, or triboelectric charge generated within the tanks. These ESD coatings also have to serve as the thermal control coatings to minimize the heat absorption from the sun, and therefore face the same challenge.

Yet another example of such application is the precipitation static (p-static) protection for airplanes. When airplanes fly through air, the collision with water droplets, ice particles, and dust particles generates triboelectric charges on their surfaces; when they fly through thunderstorms, the electric charges present in the clouds also accumulate on the surface of the airplanes. These charges create high surface potential and eventually lead to the electric breakdown and sparks. These sparks can damage the surface of the airplane and most importantly they create electrical static which interferes with onboard communication equipment, often rendering them useless. This static is called p-static. A conductive ESD coating and special design features are usually sufficient to suppress p-static except near the radome in the nose of an airplane, which houses radar and other communication devices, where a conductive ESD coating will screen electromagnetic waves and therefore affect the performance of the communication devices. An ESD coating with high resistivity is sometimes used to suppress p-static.

A different concept for ESD coating is to use a material with a high dielectric constant. The high dielectric constant ensures that the voltage build up on the surface is low even in a high flux event. Most high dielectric constant materials are inorganic solids, such as ferroelectric materials. To provide an ESD coating, the nanocrystals of such materials are usually dispersed into a polymer binder. Typical polymers and high dielectric constant materials, such as barium titanate, have poor electrical conductivity and thermal conductivity. Sufficient electrical conductivity (resistivity ˜10¹⁰ Ω·cm or smaller) of the ESD are necessary for the release of the surface charge to the nearest common ground. And sufficient thermal conductivity (0.1 W/m·K or higher) are necessary to remove excessive heat if the coating is also served as a thermal control coating. Additional filler materials, such as zinc oxide (ZnO), which possesses very high thermal conductivity and sufficient electrical conductivity, are necessary to provide sufficient thermal and electrical conductivities to the coatings.

If both the ferroelectric filler and the non-ferroelectric filler have optical bandgaps higher than 3 eV, corresponding to ˜410 nm in wavelength, they do not absorb light with wavelengths longer than their bandgap and therefore generally posses very low absorptance and high emittance in the near UV to IR spectral range, a major indicator of the efficacy of a thermal control coating. For example, BTO has a bulk bandgap of ˜3.1 eV and ZnO has a bulk bandgap of ˜3.3 eV.

If both the ferroelectric filler and the non-ferroelectric filler are inorganic oxide materials at their highest oxidization state, they may also provide the corrosion from atomic oxygen in the earth's orbit. In addition, since most metal oxides have hardness and are chemically stable, inclusion of these fillers may also provide abrasion resistance.

In this patent, we disclose a family of nanocomposites that contains at least one type of ferroelectric nanocrystals to provide high dielectric constant, along with at least one other type of inorganic nanocrystals to provide desired electrical, thermal, and/or optical properties, for specific applications such as capacitors and ESD coatings.

### DETAILED DESCRIPTION OF PRESENTLY PREFERRED EXAMPLE ILLUSTRATIVE NON-LIMITING EMBODIMENTS

One preferred exemplary illustrative embodiment provides a high dielectric constant nanocomposite. Said nanocomposite comprises at least one type of ferroelectric filler, at least one other non-ferroelectric filler, and a polymeric binder. Both the ferroelectric and non-ferroelectric fillers have sizes smaller than 1 micrometer in at least one dimension. The ferroelectric filler and the non-ferroelectric filler individually or combined may provide the high dielectric constant of the nanocomposite.

Another preferred exemplary illustrative embodiment provides high dielectric constant nanocomposite for capacitors comprising at least one type of ferroelectric filler, at least one other non-ferroelectric filler, and a polymeric binder. Both the ferroelectric and non-ferroelectric fillers have sizes smaller than 1 micrometer in at least one dimension. The ferroelectric filler and the non-ferroelectric fillers individually or combined may provide the high dielectric constant of the nanocomposite. The small size of the ferroelectric filler may contribute to the temperature stability of the dielectric constant of said nanocomposite.

Another preferred exemplary illustrative embodiment provides an ESD coating comprising at least one type of ferroelectric filler, at least one other non-ferroelectric filler, and a polymeric binder. Both the ferroelectric and non-ferroelectric fillers have sizes smaller than 1 micrometer in at least one dimension. The ferroelectric filler and the non-ferroelectric filler individually or combined may provide a high dielectric constant of the nanocomposite. The non-ferroelectric filler may provide sufficient electrical conductivity.

Another preferred exemplary illustrative embodiment provides a thermal control coating for radiation hardening of spacecraft comprising at least one type of ferroelectric filler, at least one other non-ferroelectric filler, and a polymeric binder. Both the ferroelectric and non-ferroelectric fillers have sizes smaller than 1 micrometer in at least one dimension. The ferroelectric filler and the non-ferroelectric fillers individually or combined may provide the high dielectric constant of the nanocomposite. The non-ferroelectric filler may provide sufficient electrical conductivity. The non-ferroelectric filler may provide sufficient thermal conductivity. The ferroelectric filler and the non-ferroelectric fillers individually or combined may provide sufficient high emittance/absorptance ratio. And the non-ferroelectric filler may provide sufficient resistance to atomic oxygen corrosion.

Another preferred exemplary illustrative embodiment provides a p-static protection layer for airplanes comprising at least one type of ferroelectric filler, at least one other non-ferroelectric inorganic filler, and a polymeric binder. Both the ferroelectric and non-ferroelectric fillers have size smaller than 1 micrometer in at least one dimension. The ferroelectric filler and the non-ferroelectric fillers individually or combined may provide the high dielectric constant of the nanocomposite. The non-ferroelectric filler may provide sufficient electrical conductivity. The ferroelectric filler and the non-ferroelectric fillers individually or combined may provide abrasion resistance to said nanocomposite.

In any or all of the previously disclosed exemplary illustrative embodiments, the ferroelectric filler may comprise barium titanate, barium strontium titanate, lead titanate, lead zirconate titanate, lead lanthanum zirconate titanate, lead magnesium niobate, potassium niobate, potassium sodium niobate, and any combinations and alloys of these materials. Additionally:

The ferroelectric filler may comprise nano-spheres, nano-cubes, nano-rods, nano-flakes, nano-disks, nano-rices, nano-donuts, nano-wires, nano-branches, nano-whiskers, tetrapods, and other nanoscale shapes.

The non-ferroelectric filler may comprise oxide materials.

The non-ferroelectric filler may comprise any form of nanocrystalline ZrO₂. Said ZrO₂ may provide additional benefits such as optical transparency, scratch resistance, or corrosion resistance.

The non-ferroelectric filler may comprise ZnO, ZrO₂, HfO₂, Y₂O₃, TiO₂, Indium Tin Oxide (ITO), Nb doped SrTiO₃ (STO), carbon nanotubes, graphene, carbon black, and any combinations or alloys of these materials.

The non-ferroelectric filler may completely cover the individual nanocrystals of the ferroelectric filler to form a core-shell structure.

The non-ferroelectric filler may partially cover the individual nanocrystals of the ferroelectric filler.

The non-ferroelectric filler may be dispersed together with ferroelectric filler into a polymer binder.

The fillers may have surface ligands such as organo-silanes, epoxy silanes, acetate groups, hydroxyl groups, amines, thiols, alcohol, trioctyl phosphine oxide, trioctyl phosphine, carboxylic acids, phosphonic acids, or any other surfactants and capping agents to promote dispersion or provide additional functionalities to the nanocomposites.

The binder is selected from the group consisting of epoxy, silicone, varnish, rubber, polyester, polyethylene, terephthalate, polyurethene, polyurea, polyacrylates, polyacrylics, polycarbonate, polyamide, polyimide, spin-on-glass, and other commonly used polymers or their co-, ter-, tetra-polymers.

The binder may comprise high dielectric polymers with dielectric constant higher than 5.

The coating of said nanocomposite may be formed by mixing the fillers, the binder, and solvent or mixture of solvents using stirring, agitation, sonication, homogenization, ball milling, extrusion, shear mixing, three roll mixing, or any other standard dispersing techniques, and then applied using spin-coating, dipping, spraying, spreading, draw bar printing, screen printing, and any other standard film preparation techniques to form a coating, and then cured or sintered at high temperature to remove the solvent and/or the polymeric binder.

### Examples

A common example for all the previously disclosed preferred exemplary illustrative embodiments is a high dielectric constant nanocomposite comprising barium titanate nanocrystals and zinc oxide tetrapods dispersed in an epoxy binder. Zinc oxide tetrapod nanocrystal is a specific crystal form of zinc oxide which comprises a zinc blende core with four wurtzite arms radiating out from the core symmetrically. The particle size of said barium titanate nanocrystals may vary from 2 nm to 500 nm, preferably from 30 nm-200 nm. The volume loading of said barium titanate nanocrystals may vary from 1% to 99%. The arm length of said zinc oxide tetrapods may vary from 2 nm to 50 μM. The volume loading of said zinc oxide tetrapods may vary from 1% to 80%, preferably 0.1% to 40%.

A high dielectric constant nanocomposite may comprise barium titanate nanocrystals and zinc oxide nano-rods and/or nano-wires dispersed in an epoxy matrix. The particle size of said barium titanate nanocrystals may vary from 2 nm to 500 nm, preferably from 30 nm-200 nm. The volume loading of said barium titanate nanocrystals may vary from 1% to 99%. The length of said zinc oxide nano-rods or nano-wires may vary from 2 nm to 50 μM. The diameter of said zinc oxide nano-rods may vary from 1 nm to 1 μM. The volume loading of said zinc oxide nanorods or nano-wires may vary from 0.1% to 80%, preferably 0.1% to 40%.

A high dielectric constant nanocomposite comprises barium titanate nanocrystals dispersed in an epoxy with zinc oxide nanocrystals attached directly on the surfaces of the barium titanate nanocrystals. The particle size of said barium titanate nanocrystals may vary from 2 nm to 500 nm, preferably from 30 nm-200 nm. The volume loading of said barium titanate nanocrystals may vary from 1% to 99%. The particle size of said zinc oxide nanocrystals may vary from 2 nm to 500 nm. The volume loading of said zinc oxide nanocrystals may vary from 0.1% to 80%, preferably 0.1% to 40%.

An example of a high dielectric constant nanocomposite comprises BTO nanocrystals at least partially covered with ZnO dispersed in a polymer matrix. The method of forming a nanocomposite comprises mixing BTO nanocrystals with zinc nitrate and hexamethylenetetramine (HMTA) in water, and then evaporating the water, baking the dried mixture at temperatures between 300 and 700 C, grinding or ball-milling the final product into a fine power, and dispersing said fine powder into a binder to form a nanocomposite.

Another example of providing a high dielectric constant nanocomposite comprising BTO nanocrystals at least partially covered with ZnO dispersed in a polymer matrix. The method comprises dispersing BTO nanocrystals in toluene and degassing the solution under argon environment, then adding diethyl zinc dissolved in toluene to the BTO solution dropwise and stirring to form a Zn containing layer. Water in toluene solution dropwise to the BTO solution is then added to form a ZnO layer, alternating the diethyl zinc and water addition several times to at least partially cover the surface of the BTO nanocrystals. The particle size of said barium titanate nanocrystals may vary from 2 nm to 500 nm, preferably from 30 nm-200 nm.

An example of providing ZnO tetrapods comprises evaporating pure zinc under high temperature in an argon gas flow. Said high temperature may vary between 700° C. and 1000° C. Said Argon gas flow carries said zinc vapor flows downstream into a reaction zone with a different high temperature. Said different high temperature may vary between 700° C. and 1000° C. Oxygen or air is fed to the said reaction zone to react with zinc vapor and produce ZnO tetrapods. Said tetrapods is then collected by air-trap, filtering, or solvent spraying.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

1. A nanocomposite comprising:
at least one ferroelectric filler, and at least one non-ferroelectric filler,
said at least one ferroelectric filler and at least one non-ferroelectric filler have sizes smaller than one micrometer in at least one dimension,
said at least one ferroelectric filler and at least one non-ferroelectric filler individually or combined providing high dielectric constant of the nanocomposite.

2. A nanocomposite of claim 1 wherein said non-ferroelectric filler provides IR emittance higher than 0.5 and solar absorptance smaller than 0.3 to said nanocomposite.

3. A nanocomposite of claim 1 wherein said at least one non-ferroelectric filler provides electrical conductivity.

4. A nanocomposite of claim 1 wherein said at least one non-ferroelectric filler provides thermal conductivity.

5. A nanocomposite of claim 1 wherein said at least one ferroelectric filler and said at least one non-ferroelectric filler individually or combined provides IR emittance higher than 0.5 emissivity and solar absorptance smaller than 0.3 to said nanocomposite.

6. A nanocomposite of claim 1 wherein said at least one ferroelectric filler and said at least one non-ferroelectric filler individually or combined provide atomic oxygen corrosion resistance to said nanocomposite in space.

7. A nanocomposite of claim 1 wherein said at least one ferroelectric filler and said at least one non-ferroelectric filler individually or combined may provide abrasion resistance to said nanocomposite.

8. A nanocomposite of claim 1 wherein said at least one ferroelectric filler comprises at least one of barium titanate, barium strontium titanate, lead titanate, lead zirconate titanate, lead lanthanum zirconate titanate, lead magnesium niobate, potassium niobate, potassium sodium niobate, and any combinations and alloys of these materials.

9. A nanocomposite of claim 1 wherein said at least one non-ferroelectric filler comprises one or more metal oxides.

10. A nanocomposite of claim 1 wherein said at least one non-ferroelectric filler comprises one or more nitrides.

11. A nanocomposite of claim 1 wherein said at least one non-ferroelectric filler comprises one or more metals.

12. A nanocomposite of claim 1 wherein said at least one non-ferroelectric filler comprises ZrO₂

13. A nanocomposite of claim 1 wherein said at least one non-ferroelectric filler comprises at least one of ZnO, ZrO₂, HfO₂, Y₂O₃, TiO₂, ITO, Nb doped STO, carbon nanotubes, graphene, carbon black, and any combinations and alloys of these materials.

14. A nanocomposite of claim 1 wherein said at least one non-ferroelectric filler comprises at least one of nano-spheres, nano-cubes, nano-rods, nano-flakes, nano-disks, nano-rices, nano-donuts, nano-wires, nano-branches, nano-whiskers, tetrapods, and other nanoscale shapes.

15. A nanocomposite of claim 1 wherein said at least one ferroelectric filler and at least one non-ferroelectric filler comprises surface ligands such as organo-silanes, epoxy silanes, acetate groups, hydroxyl groups, amines, thiols, alcohol, trioctyl phosphine oxide, trioctyl phosphine, carboxylic acids, phosphonic acids, or any other surfactants and capping agents.

16. A nanocomposite of claim 1 wherein said at least one ferroelectric filler and at least one non-ferroelectric filler are dispersed in a binder.

17. A nanocomposite of claim 15 wherein said binder is selected from the group consisting of epoxy, silicone, varnish, rubber, polyester, polyethylene, terephthalate, polyurethene, polyurea, polyacrylates, polyacrylics, polycarbonate, polyamide, polyimide, spin-on-glass, and other commonly used polymers or their co-, ter-, tetra-polymers.

18. A nanocomposite of claim 15 wherein said polymeric binder has a dielectric constant higher than 5.

19. An article of manufacture comprising:
at least one ferromagnetic material having particle sizes smaller than one micrometer in at least one dimension;
at least one non-ferromagnetic material having particle sizes smaller than one micrometer in at least one dimension;
wherein the article provides a higher dielectric constant than either the ferromagnetic or non-ferromagnetic material by itself.
